(19) United States
(12) Patent Application Publication
(10) Pub. No.: US 2019/0343136 A1
(43) Pub. Date: Nov. 14, 2019

(54) METHOD OF MAKING DRIED POROUS FOOD PRODUCTS

(71) Applicant: ENWAVE CORPORATION, Delta (CA)

(72) Inventors: Timothy D. DURANCE, Vancouver (CA); Guopeng ZHANG, Surrey (CA)

(21) Appl. No.: 16/474,781

(22) PCT Filed: Apr. 13, 2017
(86) PCT No.: PCT/CA2017/050469

§ 371 Date: Jun. 28, 2019

(51) Int. Cl. A23B 7/024; A23B 4/037; A23L 17/40; A23L 19/00; A23L 19/10; A23L 19/12

(52) U.S. Cl. CPC A23B 7/024; A23B 4/037; A23L 19/14; A23L 19/03; A23L 19/105; A23L 17/40

(57) ABSTRACT

A method of making a porous, crunchy, dehydrated, vegetable, meat or seafood snack product. A piece of vegetable, such as potato, sweet potato, carrot, beet or parsnip, or a piece of meat or seafood, is frozen, forming ice crystals within the piece of food. The frozen piece is exposed to microwave radiation in a microwave-vacuum dehydrator at a vacuum pressure at which the boiling point of water is above 0° C., causing the frozen piece to thaw and water to evaporate from the thawed piece. The evaporation leaves pores that were formed by the ice crystals within the piece of food, resulting in a porous, crunchy, dehydrated snack product.

### FIELD OF THE INVENTION

The invention pertains to methods of making dried food products having a porous structure and crunchy texture, based on vegetables, meats or seafood, using freezing and microwave vacuum-drying.

### BACKGROUND OF THE INVENTION

It is known in the food processing art to make dehydrated food products by means of microwave vacuum-dehydration. Examples in the patent literature are WO 2014/085897 (Durance et al.), which discloses the production of dehydrated cheese pieces, and U.S. Pat. No. 6,312,745 (Durance et al.), which discloses the production of dehydrated berries.

Where a dried vegetable, meat or seafood product is intended as a snack food, it is desirable that it have a porous structure and crunchy texture. The present invention is directed to methods for making such food products.

### SUMMARY OF THE INVENTION

The invention provides a method of making a shelf-stable food, using freezing and dehydration under particular conditions in a microwave-vacuum dehydrator.

One aspect of the invention provides a method of making a porous, crunchy, dehydrated vegetable-, meat- or seafood-based food product. A piece of food comprising vegetable, meat or seafood is frozen and exposed to microwave radiation in a microwave-vacuum dehydrator at a pressure that is less than atmospheric and at which the boiling point of water is above 0° C. This causes the frozen food piece to rapidly thaw and water to evaporate from the thawed food piece, resulting in the crunchy, dehydrated food product. The freezing causes the formation of ice crystals within the food piece, leaving pores (i.e. cavities) when the ice crystals are removed. The microwave-vacuum drying, under the selected conditions, leaves the pores intact, resulting in a highly porous structure.

Another aspect of the invention provides a porous, crunchy, dehydrated vegetable, meat or seafood product made by the method of the invention.

Further aspects of the invention and features of specific embodiments of the invention are described below.

### DETAILED DESCRIPTION

The method of the invention begins with a piece of vegetable, meat or seafood and produces from it a porous, dried, crunchy food product, intended as a shelf-stable snack food. Examples of suitable vegetables include potato, sweet potato, carrot, beet and parsnip. Examples of suitable meats include beef and sausages, and examples of suitable seafood includes shrimp and mussels. The food may also be a composite food piece, for example comprising shredded vegetable, meat or seafood mixed with ingredients such as sugar, salt, starch and various seasonings. Examples of composite foods include tater tots and pot stickers.

In some embodiments of the method, the raw vegetable or piece of meat or seafood is first sliced. Blanching is an optional step for vegetables, which improves the final taste, texture and/or color for some products. The slices are then cooked and cooled down. Optionally, the moisture content of the cooked slices may be reduced, for example by air drying, prior to further treatment. However, the residual moisture content of the cooked slices should be at least 45 wt. %, in order to form enough ice crystals in the food pieces to result in a proper degree of porosity of the product.

In other embodiments of the method, the piece of food is not sliced before cooking, for example where the food is a dumpling or other composite food piece, or where a relatively larger product is preferred.

The cooked piece of food is next subjected to freezing. This is done using a low temperature freezer, for example at freezing temperatures in the range of minus 5 to minus 80° C., preferably lower than −20° C., until the food piece is completely frozen. The freezing forms ice crystals within the food piece and these crystals result in the formation of pores.

The frozen food pieces are subjected to drying by means of microwave radiation and reduced pressure in a microwave-vacuum dehydrator. Importantly, the frozen food pieces are not allowed to thaw prior to microwave-vacuum treatment. The reduced pressure in the vacuum chamber is set at a pressure at which the boiling point of water is above 0° C., for example an absolute pressure in the range of 5 to 100 Torr, alternatively 20 to 40 Torr. The boiling point of water at these pressures is 1° C. at 5 Torr, 22° C. at 20 Torr, 34° C. at 40 Torr, and 51° C. at 100 Torr. The food pieces rapidly thaw in the dehydrator under the microwave-vacuum treatment, and evaporation of water causes steam pressure to be created in the pores formed by the ice crystals, preventing the pores from collapsing. The dried food product is thus highly porous. It has a texture that is superior to that of product prepared by microwave-vacuum treatment of food pieces that are unfrozen or that are thawed prior to treatment.

The step of drying may be conducted in two stages having different conditions in order to optimize the drying conditions and quality of the product. For example, in the first stage, the microwave power level may be higher than in the second stage. In the first stage, higher power is used to achieve faster drying. Lower power is used in the second stage to avoid over-drying and excessive temperatures in dry portions of the load that may lead to dark or burned portions. Or, in the different stages, the drying time or the speed of rotation of the product basket (where a rotating basket is employed to tumble the product during drying) may be different. Likewise, more than two drying stages may be employed.

The food pieces are dried to the desired moisture level, for example vegetables to a moisture level less than 5 wt. %, alternatively less than 3 wt. %, or meats and seafood to a moisture level less than 10 wt. %, alternatively less than 7 wt. %. The radiation is then stopped, the pressure in the vacuum chamber is equalized with the atmosphere, and the porous, crunchy, dehydrated food product is removed from the microwave-vacuum dehydrator. It will be understood that “drying” means that the moisture level is reduced to a desired level, not necessarily to zero.

An example of a microwave-vacuum dehydrator that is suitable for drying the frozen food pieces in the present invention is a resonant cavity-type microwave apparatus, as shown in WO 2009/049409 (Durance et al.), commercially available from EnWave Corporation of Vancouver, Canada, under the trademark nutraREV. Using this type of apparatus, the frozen food pieces are placed for drying in a cylindrical basket that is transparent to microwave radiation and has openings to permit the escape of moisture. The loaded basket is placed in the vacuum chamber with its longitudinal axis oriented horizontally. The pressure in the chamber is reduced. The microwave generator is actuated to radiate microwaves in the vacuum chamber and the basket is rotated within the vacuum chamber, about a horizontal axis, so as to slowly and gently tumble the food pieces. The rotation of the basket may be effected, for example, by means of rollers on which the basket is supported, or by means of a rotatable cage in which the basket is placed.

Another example of a microwave-vacuum dehydrator suitable for carrying out the step of drying is a travelling wave-type apparatus, as shown in WO 2011/085467 (Durance et al.), commercially available from EnWave Corporation under the trademark quantaREV. The frozen food pieces are fed into the vacuum chamber and conveyed across a microwave-transparent window on a conveyor belt while being subjected to drying by means of low pressure and microwave radiation. With this type of apparatus, the food pieces are dried while resting on a tray or the conveyor belt, and are not subjected to tumbling.

### EXAMPLES

### Example 1: Potato Chip Product

A red potato was rinsed with water, peeled, cut into 7 mm slices, cooked in steam for 10 minutes and then cooled down. The cooked slices were frozen at −80° C. for 1 hour and then transferred to a −20° C. freezer. The solidly frozen slices were mixed with 1 wt. % vegetable oil to avoid sticking of product to itself or the drying basket wall. 915 grams of the frozen slices were placed in a perforated polypropylene drying basket. The basket was loaded into a nutraREV microwave-vacuum dehydrator manufactured by EnWave Corporation. The dehydrator has a pair of spaced horizontal rollers for rotation of the basket. The basket was rotated about its longitudinal, horizontal axis at 5 rpm during the drying process. The drying was done in two stages, namely, a first stage at 2000 W of power for a processing time of 1647 seconds, followed by a second stage at 750 W of power for 564 seconds, all at an absolute pressure in the range of 24 to 26 Torr. The final weight of the dried, porous, crunchy potato pieces was 170 grams (an 18.5 wt. % yield) and the final moisture level was 5 wt. %.

### Example 2: Sweet Potato Chip Product

An Asian yellow sweet potato (Ipomoea genus) was rinsed with water, peeled, cut into 5 mm slices, cooked in steam for 10 minutes and then cooled down. The moisture content of the cooked sweet potato was about 77 wt. % The cooked slices were frozen in a −20° C. freezer. The solidly frozen slices were mixed with 1 wt. % vegetable oil. 920 grams of the frozen slices were placed in a perforated polypropylene drying basket. The basket was loaded into a nutraREV microwave-vacuum dehydrator. The basket was rotated about its longitudinal, horizontal axis at 5 rpm during the drying process. The drying was done in two stages, namely, a first stage at 2000 W of power for a processing time of 1660 seconds, followed by a second stage at 750 W of power for 740 seconds, all at an absolute pressure in the range of 24 to 26 Torr. The final weight of the dried, porous, crunchy sweet potato pieces was 210 grams (a 22.8 wt. % yield) and the final moisture level was 5 wt. %.

### Example 3: Crunchy Beef Chips

A piece of beef (eye of round) was frozen for 1 hour, and then sliced to 6 mm in thickness. The fat was trimmed off. A beef jerky seasoning was added, comprising 0.062 kg seasoning per kg of beef and 0.032 kg water per kg of beef. The beef and seasoning were mixed well and marinated at 4° C. for 1 hour. The beef slices were place in a single layer on trays and frozen at −20° C. for 48 hours. Their initial moisture, after freezing, was 71 wt. %. 1000 grams of the frozen slices were placed in a perforated polypropylene drying basket. The basket was loaded into a nutraREV microwave-vacuum dehydrator. The basket was rotated about its longitudinal, horizontal axis at 8 rpm during the drying process. The drying was done in two stages, namely, a first stage at 2000 W of power for a processing time of 1000 seconds, followed by a second stage at 600 W of power for 1700 seconds, all at an absolute pressure in the range of 24 to 26 Torr. The maximum temperature reached in the microwave-vacuum dehydrator was 80° C. The dried slices were then subjected to air drying at 85° C. for 600 seconds.

### Example 4: Fermented Extra Lean Salami Sausage

Sausages were sliced to 3 mm in thickness and the slices were frozen at −20° C. for 48 hours. Their initial moisture content, after freezing, was 45.5 wt. %. 1080 grams of the frozen slices were placed in a perforated polypropylene drying basket. The basket was loaded into a nutraREV microwave-vacuum dehydrator. The basket was rotated about its longitudinal, horizontal axis at 8 rpm during the drying process. The drying was done in two stages, namely, a first stage at 2000 W of power for a processing time of 1000 seconds, followed by a second stage at 750 W of power for 1080 seconds, all at an absolute pressure in the range of 24 to 26 Torr. The weight of the dried, porous, crunchy slices was 630 grams. The final moisture content was 6.42 wt. %. The product was very soft but crunchy texture, entirely different from, and superior to, a control product made using non-frozen slices of sausage.

### Example 5: Frozen Cooked Peeled Shrimps

Frozen cooked shrimp were purchased at a grocery store and 1720 grams was loaded still frozen into a perforated polypropylene nutraREV drying basket. The initial moisture was 85 wt. %. The basket was loaded into a nutraREV microwave vacuum dehydrator. The basket was rotated about its longitudinal, horizontal axis at 8 rpm during the drying process. The drying was done in two stages, namely, a first stage at 2000 W of power for a processing time of 2700 seconds, followed by a second stage at 750 W of power for 720 seconds, all at an absolute pressure in the range of 23 to 27 Torr. The final temperature was 48° C. The weight of the dried, porous, crunchy shrimp was 267 grams. The final moisture content was 6.0 wt. %.

### Example 6: Frozen sweet potato Tater Tot Puffs

Frozen reformed sweet potato bites made of shredded sweet potato tuber, pre-blanched, shaped and frozen, were purchased at a grocery store. A portion of 1175 grams was loaded still frozen into a perforated polypropylene nutraREV drying basket. The initial moisture was 59.9% by weight. The basket was loaded into a nutraREV microwave-vacuum dehydrator. The basket was rotated about its longitudinal, horizontal axis at 8 rpm during the drying process. The drying was done in two stages, namely, a first stage at 2000 W of power for a processing time of 1500 seconds, followed by a second stage at 750 W of power for 1600 seconds, all at an absolute pressure in the range of 23 to 27 Torr. The final temperature was 77° C. The weight of the dried, porous, crunchy shrimp was 475 grams. The final moisture content was 5.0 wt. %.

### Example 7 Pot Stickers

Pot stickers (Asian dumpling including minced vegetables and chicken in a pasta or noodle wrapper) were prepared. They were frozen in a −20° C. freezer. The moisture content of the frozen pot stickers was about 61 wt. %. The solidly frozen pot stickers were mixed with 1 wt. % vegetable oil. 1735 grams of the frozen pot stickers were placed in a perforated polypropylene drying basket which was loaded into a nutraREV microwave-vacuum dehydrator. The basket was rotated about its longitudinal, horizontal axis at 8 rpm during the drying process. The drying was done in two stages, namely, a first stage at 2000 W of power for a processing time of 2300 seconds, followed by a second stage at 750 W of power for 903 seconds, all at an absolute pressure in the range of 24 to 26 Torr. The final product temperature was about 102° C. The weight of the dried, porous, pot stickers was 695 grams and the moisture content was 3.5 wt. %.

As will be apparent to those skilled in the art in the light of the foregoing disclosure, many alterations and modifications are possible in the practice of this invention without departing from the scope thereof. The scope of the invention is to be construed in accordance with the following claims.

1. A method of making a porous, crunchy, dehydrated food product, comprising:
(a) cooking a piece of food, the food being one of a vegetable, meat and seafood;
(b) freezing the cooked piece of food, the cooked piece of food having a moisture content of 45 wt. % or higher, and thereby forming ice crystals in the piece of food;
(c) exposing the frozen piece of food to microwave radiation in a microwave-vacuum dehydrator at a pressure that is less than atmospheric and at which the boiling point of water is above 0° C., causing the frozen piece of food to thaw and water to evaporate from the thawed piece of food, leaving pores formed by the ice crystals within the piece of food, to produce the porous, crunchy, dehydrated food product.

2. A method according to claim 1, wherein the food comprises a vegetable selected from the group consisting of potato, sweet potato, carrot, beet and parsnip.

3. A method according to claim 1, wherein the food comprises meat or seafood.

4. (canceled)

5. A method according to claim 3, wherein the seafood comprises shrimp or mussels.

6. A method according to claim 1, wherein step (a) is done for a time period of at least 10 minutes.

7. A method according to claim 1, further comprising the step of reducing moisture content of the piece of food before step (b).

8. A method according to claim 1, wherein step (b) is done at a temperature in the range of −80° C. to −5° C.

9. A method according to claim 1, wherein step (b) is done at a temperature of −20° C. or less.

10. A method according to claim 1, wherein step (c) is done at an absolute pressure in the range of 5 to 100 Torr.

11. A method according to claim 1, wherein step (c) is done at a pressure in the range of 20 to 40 Torr.

12. A method according to claim 1, wherein the piece of food is a composite food comprising the vegetable, meat or seafood and one or more of sugar, salt, starch and seasoning.

13. A method according to claim 2, wherein the porous, crunchy, dehydrated food product has a moisture content less than 5 wt. %.

14. A method according to claim 2, wherein the porous, crunchy, dehydrated food product has a moisture content less than 3 wt. %.

15. A method according to claim 3, wherein the porous, crunchy, dehydrated food product has a moisture content less than 10 wt. %.

16. A method according to claim 3, wherein the porous, crunchy, dehydrated food product has a moisture content less than 7 wt. %.

17. A method according to claim 1, further comprising, during step (c), tumbling the pieces of food in the microwave-vacuum dehydrator.

18. A method according to claim 1, wherein step (c) is done in at least two stages and a microwave power level of the microwave-vacuum dehydrator is higher in a first stage than in a second stage.

19. A method according to claim 1, wherein step (c) causes the formation of steam in the pores, preventing collapse of the pores.

20. A method according to claim 1, wherein the dehydrator is a resonant cavity microwave dehydrator.

21. A method according to claim 1, wherein the dehydrator is a travelling wave microwave dehydrator.

22. A dried, crunchy, food product made by the method of claim 1.

23. A food product comprising crunchy potato having pores therein and a moisture content less than 5 wt. %.

24. A food product comprising crunchy sweet potato having pores therein and a moisture content less than 5 wt. %.

25. A food product comprising crunchy meat or seafood having pores therein and a moisture content less than 10 wt. %.
